(19) United States
(12) Patent Application Publication
(10) Pub. No.: US 2026/0257971 A1
(43) Pub. Date: Sep. 3, 2026

(54) MANUFACTURING METHOD OF CURED BODY

(71) Applicants: THE UNIVERSITY OF TOKYO, Tokyo (JP); TOKYO UNIVERSITY OF SCIENCE FOUNDATION, Tokyo (JP); TAIHEIYO CEMENT CORPORATION, Tokyo (JP)

(72) Inventors: Ippei MARUYAMA, Bunkyo-ku (JP); Takafumi NOGUCHI, Bunkyo-ku (JP); Kien Ngoc BUI, Bunkyo-ku (JP); Manabu KANEMATSU, Shinjuku-ku (JP); Hikotsugu HYODO, Bunkyo-ku (JP); Hiroshi HIRAO, Bunkyo-ku (JP)

(73) Assignees: THE UNIVERSITY OF TOKYO, Tokyo (JP); TOKYO UNIVERSITY OF SCIENCE FOUNDATION, Tokyo (JP)

(21) Appl. No.: 19/155,018

(22) PCT Filed: Aug. 2, 2023
(86) PCT No.: PCT/JP2023/028333

§ 371 Date: Aug. 8, 2025

(30) Foreign Application Priority Data
Feb. 15, 2023 (JP) 2023-021898

(51) Int. Cl. C04B 28/04; B28B 3/00; C04B 22/08; C04B 22/10; C04B 22/12; C04B 22/14

(52) U.S. Cl. CPC C04B 28/04; C04B 22/082; C04B 22/106; C04B 22/124; C04B 22/143; B28B 3/00

(57) ABSTRACT

A manufacturing method of a cured body, includes: mixing a composition containing a carbonate containing one or more elements selected from calcium and magnesium or a hydrate, and a liquid containing a soluble alkaline earth metal salt, and subjecting a resulting mixture to pressure molding to produce a molded body; and drying the molded body.

### TECHNICAL FIELD

The present invention relates to a manufacturing method of a cured body.

### BACKGROUND ART

Concrete is one of the principal construction materials. Meanwhile, it is becoming difficult to procure high-quality aggregate resources, and the limitations of the limestone reserves, which are the main raw material of cement, are beginning to become apparent. In particular, the manufacturing of concrete using limestone is gradually becoming difficult. Therefore, the reuse of waste concrete is being studied, and the waste concrete is being recycled as aggregate. However, a complete reuse method for the aggregate and cement paste parts has not yet been established. This is because a method for reusing the cement paste part as a binder in concrete has not yet been resolved. Therefore, the reuse of waste concrete is still in the stage of research and investigation, and has not yet reached full practical application.

In recent years, as a new attempt at the reuse of waste concrete, it has been reported that by crushing waste concrete and performing compression molding, it can be regenerated as a cured body having sufficient strength without performing selection or separation of aggregate or the like (Non-Patent Literature 1 and 2).

### CITATION LIST

### Non-Patent Literature

Non-Patent Literature 1: Yuya SAKAI et al., Journal of the Journal of Japan Society of Civil Engineers, Ser. E2 (Materials and Concrete Structures), Vol. 72, No. 1, p. 32-40 (2016)

Non-Patent Literature 2: Yuya SAKAI et al., Journal of the Journal of Japan Society of Civil Engineers, Ser. E2 (Materials and Concrete Structures), Vol. 76, No. 4, p. 306-314 (2020)

### SUMMARY OF INVENTION

### Technical Problem

However, in the prior art, a high molding pressure of 50 MPa or more is required to manufacture a cured body having sufficient strength from a pulverized product of waste concrete, a lot of energy is required, and thus an increase in cost cannot be avoided.

An object of the present invention is to provide a manufacturing method of a cured body, by which can easily manufacture a cured body having sufficient strength with low energy, and can reuse the cured body any number of times.

### Solution to Problem

Conventionally, as described above, it known that powdered waste concrete could be subjected to pressure molding to form a cured body. However, this was mainly due to the recovery of bonding through hydrogen bonding on the surface of C-S-H by applying high molding pressure, and it considered that waste concrete having undergone a carbonation reaction would not bond. However, the present inventors have found, surprisingly, that in the case of waste concrete having undergone a carbonation reaction, by mixing this with a treatment liquid such as a liquid containing a specific metal salt, subjecting the resulting mixture to pressure molding, and drying the molded body, it is possible to easily manufacture a cured body having sufficient strength with low energy, without requiring high molding pressure and even with a short loading time, and furthermore, the cured body can be reused any number of times.

That is, the present invention provides the following [1] to [9].

[1] A manufacturing method of a cured body, the method including:
a first step of mixing a composition containing a carbonate containing one or more elements selected from the group consisting of calcium and magnesium or a hydrate of the carbonate, and a treatment liquid selected from the group consisting of a liquid containing a soluble alkaline earth metal salt and an inorganic acid aqueous solution, and subjecting a resulting mixture to pressure molding to produce a molded body; and
a second step of drying the molded body.

[2] The manufacturing method of a cured body according to the above [1], in which after the first step and before the second step, a mixture of a composition containing a carbonate containing one or more elements selected from the group consisting of calcium and magnesium or a hydrate of the carbonate, and a treatment liquid selected from the group consisting of a liquid containing a soluble alkaline earth metal salt and an inorganic acid aqueous solution is laminated on the molded body produced in the first step, the resulting laminate is subjected to pressure molding, and then a desired molded body is produced by repeating Step A below.

### (Step A)

A step of laminating a mixture containing a composition containing a carbonate containing one or more elements selected from the group consisting of calcium and magnesium or a hydrate of the carbonate, and a treatment liquid selected from the group consisting of a liquid containing a soluble alkaline earth metal salt and an inorganic acid aqueous solution, on the molded body produced immediately before the Step A, and subjecting the resulting laminate to pressure molding.

[3] The manufacturing method of a cured body according to the above [1] or [2], in which the composition has a particle size distribution such that a particle size D₁₀ is 0.05 to 0.75 mm and a particle size D₅₀ of 0.25 to 5.0 mm.

[4] The manufacturing method of a cured body according to any one of the above [1] to [3], in which an used amount of the liquid is 5 to 40 mass % with respect to the composition.

[5] The manufacturing method of a cured body according to any one of the above [1] to [4], in which the soluble alkaline earth metal salt contains one or more selected from the group consisting of a soluble calcium salt and a soluble magnesium salt.

[6] The manufacturing method of a cured body according to any one of the above [1] to [5], in which the soluble alkaline earth metal salt contains one or more selected from the group consisting of calcium bicarbonate, calcium sulfate, calcium chloride, magnesium bicarbonate, magnesium sulfate, magnesium nitrate, magnesium acetate, and magnesium chloride.

[7] The manufacturing method of a cured body according to any one of the above [1] to [6], in which the inorganic acid is one or more selected from the group consisting of hydrochloric acid, carbonic acid, and sulfuric acid.

[8] The manufacturing method of a cured body according to any one of the above [1] to [7], in which pressure molding is performed for 30 seconds or more.

[9] The manufacturing method of a cured body according to any one of the above [1] to [8], in which the molded product is dried until a moisture content of the molded body after drying becomes 24 mass % or less.

### Advantageous Effects of Invention

According to the present invention, it is possible to easily manufacture a cured body having sufficient strength with low energy without requiring high molding pressure and even with a short loading time, and furthermore, the cured body can be reused any number of times. Therefore, the present invention not only enables the manufacturing of a cured body by reusing waste concrete or waste mortar, but also allows the cured body to be reused any number of times, and thus can greatly contribute to the realization of resource circulation.

### BRIEF DESCRIPTION OF DRAWINGS

FIG. 1 is a flowchart illustrating an example of a manufacturing method of the present invention.

FIG. 2(a) is a diagram illustrating a relationship between a particle frequency of a sample and a sieve mesh, and FIG. 2(b) is a diagram illustrating a particle size distribution of the sample.

FIG. 3 is a diagram illustrating the influence of the particle size distribution of the sample on a compressive strength of a cured body.

FIG. 4 is a diagram illustrating the influence of an addition amount of a treatment liquid on the compressive strength of the cured body.

FIG. 5 is a diagram illustrating the influence of loading time during pressure molding on the compressive strength of the cured body.

FIG. 6 is a diagram illustrating the influence of drying time of a molded body on the compressive strength of the cured body.

FIG. 7 is a diagram illustrating the influence of temperature during pressure molding on the compressive strength of the cured body.

FIG. 8 is a diagram illustrating the influence of drying temperature of the molded body on the compressive strength of the cured body.

FIG. 9 is a diagram illustrating the influence of a type of treatment liquid on the compressive strength of the cured body.

FIG. 10 is a diagram illustrating the influence of the mass ratio of cement/sand/water on the compressive strength of the cured body.

FIG. 11 is a diagram illustrating the influence of thickness of a mixture per layer during production of a laminate on the compressive strength of the cured body.

FIG. 12 is a diagram illustrating the influence of the addition amount of the treatment liquid on the compressive strength of the cured body.

FIG. 13 is a diagram illustrating the influence of preheating of carbonated mortar before being mixed with the treatment liquid on the compressive strength of the cured body.

FIG. 14 is a diagram illustrating the influence of a type of treatment liquid on the compressive strength of the cured body.

### DESCRIPTION OF EMBODIMENTS

Hereinafter, the manufacturing method of a cured body of the present invention will be described in detail.

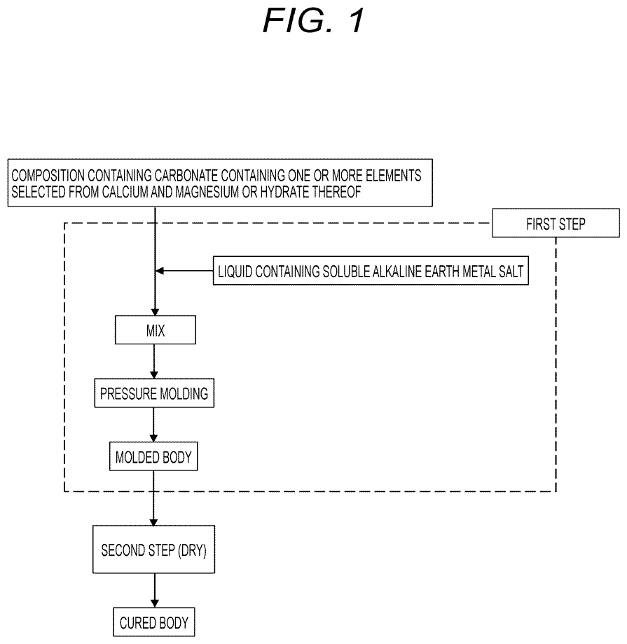

The manufacturing method of a cured body of the present invention is characterized by including a first step and a second step, and an example thereof is illustrated in FIG. 1.

### <First Step>

As illustrated in FIG. 1, this step is a step of mixing a composition (hereinafter also referred to as “specific composition”) containing a carbonate containing one or more elements selected from the group consisting of calcium and magnesium or a hydrate of the carbonate (hereinafter also referred to as “specific carbonate and the like”) with a treatment liquid selected from the group consisting of a liquid containing a soluble alkaline earth metal salt and an inorganic acid aqueous solution, and subjecting the resulting mixture to pressure molding to produce a molded body. As described above, by bringing the specific composition into contact with the treatment liquid, the specific carbonate and the like in the specific composition are dissolved and precipitated during loading, and the treatment liquid serves as a bonding aid such that formation and curing of a molded body can be promoted.

### [Specific Composition]

The specific composition is not particularly limited as long as the specific composition contains a specific carbonate or the like, and examples thereof include calcium carbonate or a hydrate thereof, hemicarbonate calcium aluminate or a hydrate thereof, monocarbonate calcium aluminate or a hydrate thereof, magnesium carbonate or a hydrate thereof, and aluminum magnesium hydroxide carbonate or a hydrate thereof.

The specific composition may contain a substance other than the specific carbonate or the like, and examples thereof include an inorganic compound, an organic compound, a pulverized product of rock, and a glassy substance. The inorganic compound other than calcium carbonate may be a hydrate, and examples thereof include calcium oxide, calcium hydroxide, calcium silicate, alumina, aluminum hydroxide, calcium aluminate, aluminum silicate, silica gel, alumina gel, magnesium oxide, iron oxide, calcium silicate hydrate, etoringite, monosulfate, ceramics, and steel fibers. Examples of the organic compound include cement-based chemical admixtures and organic fibers. Specific examples of the cement-based chemical admixture include a water reducing agent and a shrinkage reducing agent. Examples of the pulverized product of the rock include clays, and examples of the glassy substance include volcanic ash.

Examples of the specific composition containing substances other than specific carbonates and the like include cement-based waste materials such as waste concrete and waste mortar, limestone, magnesite, incineration ash, and slag. Cement-based waste materials and the like include calcium carbonate, magnesium carbonate, or hydrates thereof, which are naturally generated by the reaction of the calcium compound or the magnesium compound in the composition with carbon dioxide in the atmosphere. In addition, a specific composition may be obtained by carbonating a compound containing calcium or magnesium in a form other than calcium carbonate, magnesium carbonate, and hydrates thereof.

Examples of the cement-based waste material include, for example, disassembled concrete and mortar generated by civil engineering work, disassembly of a structure, and the like, and surplus concrete and surplus mortar generated at the time of construction of a building or the like. The aggregate may be removed from the cement-based waste material.

In addition, the blending ratio of cement, sand, and water in the cement-based waste is not particularly limited, and for example, cement-based waste material having a cement/sand/water mass ratio of 1/2/0.5, 1/3/0.5, 1/4/0.5, or 1/6/0.5 can be used. Among them, the mass ratio of cement/sand/water in the cement-based waste material is preferably 1/3/0.5 to 1/6/0.5 from the viewpoint of easily receiving the effect of the present invention.

Examples of the incineration ash include those obtained by collecting coal ash generated by combustion of pulverized coal in a thermal power plant or the like with an electric precipitator or the like, or those obtained by classifying or pulverizing the coal ash, and fly ashes I to IV defined in “JIS A 6201:2015 (Fly Ash for Concrete)”. In addition, pulverized coal in a thermal power plant or the like, clinker ash generated by combustion of biomass, biomass ash, and the like can also be exemplified. Further, city waste incineration ash, sewage sludge incineration ash, and the like are also exemplified. Among them, incineration ash generated from a fluidized bed furnace containing calcium carbonate, calcium oxide, and calcium hydroxide is preferable.

Examples of the slag include slag generated in a dissolving step or a refining step of various processes including a steel manufacturing process. Specific examples thereof include blast furnace slag, steel slag (for example, converter decarburized slag, dephosphorized slag, desilized slag, desulfurized slag, electric furnace slag, or cast slag), molten reduction slag (for example, slag generated by melt reduction of iron ore, Cr ore, Ni ore, or Mn ore), slag generated from other refining furnaces or refining furnaces, waste incineration ash molten slag, and waste gasified molten slag.

The total content of the specific carbonate and the like in the specific composition may be a slight amount or a large amount, and is not particularly limited, but is preferably 10 mass % or more, more preferably 15 mass or more, and still more preferably 20 mass % or more from the viewpoint of easily enjoying the effects of the present invention. The upper limit value of the total content of the specific carbonate and the like is not particularly limited, and may be 100 mass %. Even when carbonation proceeds as described above, a cured body having sufficient strength can be manufactured.

When a cement-based waste material is used as the specific composition, a cured body having sufficient strength can be manufactured even when the degree of carbonation is 20 mass % or more, further 40 mass; or more, or further 60 mass % or more. The upper limit value of the degree of carbonation is not limited, and may be 100 mass. Here, in the present specification, the “degree of carbonation” refers to the ratio of carbon dioxide to calcium oxide in the specific composition. The degree of carbonation can be calculated by the following Formula (i) by performing thermogravimetric analysis (TG measurement) under the following conditions and analyzing the amount of calcium carbonate from the weight loss amount (decarbonation amount) at 550 to 800° C. As the thermogravimetric analyzer, a commercially available apparatus can be used, and examples thereof include Thermo plus EV02 TG8121 (manufactured by Rigaku Corporation).

### TG-DTA Measurement Conditions

Sample amount: about 20 mg
Heating rate: 10° C./min
N₂ gas flow atmosphere: 300 mL/min

$$Degree of carbonation ( \% ) = ( X \times 56 / 44 ) / Y \times 100 \qquad ( i )$$

In Formula (i),
X represents the amount of CO₂ in the composition (mg), and
Y represents the amount of Cao in the composition (mg).

In the present invention, the content of the specific carbonate or the like can be adjusted to a desired content by mixing two or more specific compositions having different contents of the specific carbonate or the like. Further, in order to adjust the content of specific carbonates and the like in the specific composition, carbonation may be forced. In the case of forced carbonation, for example, a neutralization promoting device can be used. As the neutralization promoting device, a commercially available device can be used, and examples thereof include a neutralization promoting test device (manufactured by MARUI & Co., Ltd.). The carbon dioxide used for carbonation may be carbon dioxide filled in a commercially available cylinder, but it is preferably derived from carbon dioxide in the atmosphere or derived from carbon dioxide in various industrial exhaust gases. In particular, it is possible to contribute to immobilization of carbon dioxide in the atmosphere by being derived from carbon dioxide in various industrial exhaust gases including carbon dioxide and the like in a state of being discharged and dispersed in the atmosphere at the time of manufacturing cement by calcination.

The form of the specific composition is preferably granular, powdery, or a mixture thereof, and more preferably powdery from the viewpoint of ease of molding and strength enhancement of the cured body.

The specific composition preferably has any one of the following properties from the viewpoint of enhancing the strength of the cured body.

(i) The particle size distribution is such that the particle size D₁₀ is 0.05 to 0.75 mm and the particle size D₅₀ is 0.25 to 5.0 mm.

(ii) The particle size distribution is such that the particle size D₁₀ is 0.10 to 0.50 mm and the particle size D₅₀ is 1.5 to 5.0 mm.

(iii) The particle size distribution is such that the particle size D₁₀ is 0.10 to 0.25 mm and the particle size D₅₀ is 1.5 to 3.0 mm.

(iv) The particle size distribution is such that the particle size D₁₀ is 0.05 to 0.75 mm and the particle size D₅₀ is 0.25 to 2.5 mm.

(v) The particle size distribution is such that the particle size D₁₀ is 0.10 to 0.50 mm and the particle size D₅₀ is 1.0 to 2.25 mm.

(vi) The particle size distribution is such that the particle size D₁₀ is 0.10 to 0.25 mm and the particle size D₅₀ is 1.25 to 2.0 mm.

Here, in the present specification, the “particle size D₁₀” refers to a particle size at which a cumulative volume from a small particle side corresponds to 10 vol % in a volume-based cumulative distribution curve, and the “particle size D₅₀” refers to a particle size at which a cumulative volume from a small particle side corresponds to 50 vol % in a volume-based cumulative distribution curve. Incidentally, the volume-based cumulative distribution curve can be created by using both a sieving method using a sieve specified in JIS Z 8801-1:2019 “Test sieve—Part 1: Metal mesh sieve” and a laser diffraction/scattering method specified in JIS R 1629 “Method for measuring particle size distribution of fine ceramic raw material by laser diffraction/scattering method”, and for example, Microtrac MT3300EX II (manufactured by Microtrac Retsch GmbH) can be used as a particle size distribution measuring device by a laser diffraction/scattering method.

In order to adjust the specific composition to a desired particle size, one or more selected from the group consisting of crushing, pulverizing, and sieving can be performed.

Crushing can be performed using a crusher, and examples thereof include a jaw crusher, an impact crusher, a hammer crusher, a roll crusher, and a rotary crusher. In order to adjust the particle size of waste concrete, a screen of a desired sieve is attached to the crusher, or when the screen is not attached, fixed teeth, rotating teeth, an inner wall, and the like may be adjusted to a desired clearance.

The pulverization can use a pulverizer, and examples thereof include a disc mill, a Wonder Blender, a rod mill, a ball mill, and a roller mill.

Sieving can be performed using a sieving machine, and for example, any of vibrating type, in-plane motion type, rotary type, and stationary type can be used. Examples of the type of sieve include a woven mesh made of metal or non-metal, a punching mesh, a welding mesh, a wedge wire screen, and comb teeth, and can be appropriately selected.

### [Treatment Liquid]

As the treatment liquid to be mixed with the specific composition, a liquid containing a soluble alkaline earth metal salt or an inorganic acid aqueous solution can be appropriately selected and used.

### (Liquid Containing Soluble Alkaline Earth Metal Salt)

The liquid containing the soluble alkaline earth metal salt is not particularly limited as long as the soluble alkaline earth metal is contained, and may be a solution or a liquid suspended or dispersed, for example, a slurry.

The solvent contained in the liquid is usually water. Examples of the water include, but are not limited to, pure water, tap water specified in JIS A 5308 Annex C, and water other than the tap water (for example, rainwater, river water, lake water, well water, groundwater, and industrial water). As used herein, the term “soluble” means being soluble in water.

The soluble alkaline earth metal salt is not particularly limited as long as it is soluble, and may be any of soluble beryllium salts, soluble magnesium salts, soluble calcium salts, soluble strontium salts, soluble barium salts, and soluble radium salts. However, in terms of easily enjoying the effects of the present invention, it is preferable to include one or more soluble alkaline earth metal salts selected from the group consisting of soluble calcium salts and soluble magnesium salts.

Examples of the soluble calcium salt include calcium bicarbonate, calcium sulfate, and calcium chloride, and may be in the form of a hydrate. One or two or more soluble calcium salts can be contained.

Examples of the soluble magnesium salt include magnesium bicarbonate, magnesium sulfate, magnesium nitrate, magnesium acetate, and magnesium chloride, and may be in the form of a hydrate. Incidentally, one or two or more soluble magnesium salts can be contained.

Among them, the soluble alkaline earth metal salt preferably contains one or more selected from the group consisting of calcium bicarbonate, calcium sulfate, calcium chloride, magnesium sulfate, magnesium nitrate, magnesium acetate, and magnesium chloride, and more preferably contains one or more selected from the group consisting of calcium bicarbonate, calcium chloride, magnesium bicarbonate, and magnesium chloride, from the viewpoint of promoting dissolution of the specific carbonate and the like and enhancing the strength of the cured body.

When the reagent is used as the soluble alkaline earth metal salt, the preparation of the liquid is not particularly limited, and for example, the soluble alkaline earth metal salt and water may be added simultaneously, or one may be added to the other.

The soluble alkaline earth metal salt may also be derived, for example, from a composition containing a calcium source and/or a magnesium source. Examples of such a composition include waste materials such as limestone and waste concrete, cement hydrate recovered from raw concrete waste water sludge, and seawater. When carbon dioxide is blown into a liquid containing such a composition, a liquid containing calcium bicarbonate and/or magnesium bicarbonate can be prepared. Here, in the present specification, the “raw concrete wastewater sludge” refers to washing wastewater of concrete kneading, transportation, molding equipment, and the like in a raw concrete plant, a cement secondary product plant, and the like, and washing wastewater of return concrete and the like that is surplus at a raw concrete transportation destination.

As a method for blowing carbon dioxide, a conventionally known method can be used as long as carbon dioxide can be dissolved in a liquid to generate bicarbonate. For example, a method using a machine such as bubbling, a pore type, a pressurized dissolution type, an ultrasonic type, a swirling liquid flow type, or a gas-liquid mixed shear type can be exemplified, but the method is not limited thereto. The blowing amount of carbon dioxide is, for example, preferably 50% or more, more preferably 70% or more, and still more preferably 90% or more with respect to the saturation amount. Carbon dioxide similar to that used for carbonation can be used. In addition, the carbon dioxide used is preferably one having a high carbon dioxide concentration, since this accelerates the generation of bicarbonate.

The content of the soluble alkaline earth metal salt in the liquid is, as the content of the alkaline earth metal ion in the liquid, preferably 600 mass ppm or more, more preferably 800 mass ppm or more, still more preferably 1,500 mass ppm or more, and even more preferably 2,000 mass ppm or more from the viewpoint of promoting dissolution of the specific carbonate or the like and enhancing the strength of the cured body. Since the dissolution of calcium carbonate is promoted as the content of the alkaline earth metal ions is higher, the upper limit value of the content of the alkaline earth metal ions in the liquid is not particularly limited, and may be a saturated amount. The content of calcium ions can be measured by an ICP emission spectrometer (Thermoscientific, iCAP Pro).

### (Inorganic Acid Aqueous Solution)

The inorganic acid is not particularly limited, and any inorganic acid can be used. Examples thereof include hydrogen acids such as hydrochloric acid, hydroiodic acid, hydrofluoric acid, and hydrocyanic acid, and oxoacids such as sulfuric acid, nitric acid, carbonic acid, phosphoric acid, boric acid, hydrosulfide acid, perchloric acid, chlorous acid, hypochlorous acid, and chromic acid.

Among them, one or more selected from the group consisting of hydrochloric acid, carbonic acid, and sulfuric acid are preferable from the viewpoint of easily enjoying the effects of the present invention.

The concentration of the inorganic acid aqueous solution can be appropriately selected, but is usually 0.1 to 0.8 mol/L and preferably 0.2 to 0.6 mol/L.

Before mixing the specific composition and the treatment liquid, the specific composition or the treatment liquid may be heated. The heating temperature of the specific composition and the treatment liquid can be appropriately selected, and for example, in the case of the specific composition, the heating temperature is usually 20 to 100° C., preferably 50 to 95° C., and more preferably 60 to 90° C. The heating temperature of the treatment liquid is usually 20 to 90° C., preferably 30 to 80° C., and more preferably 40 to 70° C. By setting the temperature to such a temperature, the strength of the cured body can be further enhanced.

### [Mixing]

The method for mixing the specific composition and the treatment liquid is not particularly limited as long as the specific composition and the treatment liquid can be brought into contact with each other. The mixing method may be, for example, hand mixing or a mixer. As the mixer, for example, a mixer can be used, and examples thereof include a grout mixer, a pan-type mixer, a biaxial mixer, and a hand mixer. In the mixing order, both may be added and mixed at the same time, or one may be added to the other and mixed.

The mixing temperature is usually room temperature (20° C.±15° C.).

The mixing time can be appropriately selected as long as the specific composition and the liquid containing the soluble alkaline earth metal salt can be mixed substantially uniformly.

The used amount of the treatment liquid is preferably 5 mass % or more, more preferably 10 mass % or more, and still more preferably 15 mass % or more, and is preferably 40 mass % or less, more preferably 35 mass % or less, and still more preferably 30 mass % or less with respect to the specific composition from the viewpoint of promoting dissolution of the specific carbonate or the like and enhancing the strength of the cured body.

From the viewpoint of promoting the development of strength, a chemical admixture may be added at the time of mixing. Examples of the chemical admixture include a water reducing agent, an AE agent, an AE water reducing agent, a shrinkage reducing agent, and an amine. The water reducing agent, the AE agent, the AE water reducing agent, and the shrinkage reducing agent are not particularly limited as long as they are generally used in the art. Examples of the amine include used alkanolamines obtained from a carbon dioxide recovery apparatus, and alkanolamines such as monoethanolamine (MEA) and triisopropanolamine (TIPA). The used amount of the additive can be appropriately selected as long as the effect of the present invention is not impaired.

### [Pressure Molding]

The pressure molding may be performed, for example, by placing the mixture in a mold or the like. The shape of the mold can be appropriately selected according to the use of the cured body.

In addition, aggregates, fibers, and the like may be mixed at the time of molding.

Examples of the aggregate include those obtained by pulverizing gravel, sand, rock, or the like collected from a river, a sea, or the like, and regenerated aggregates.

Examples of the fibers include those commercially available as materials for concrete, such as steel fibers for concrete, carbon fibers, glass fibers, basalt fibers (basalt fiber which is obtained by melting basalt and vitrifying the basalt to make fibers), and plastic fibers.

The blending amounts of the aggregate and the fiber can be appropriately selected within a range not impairing the object of the present invention.

The molding pressure is preferably 15 MPa or more, more preferably 20 MPa or more, still more preferably 25 MPa or more, and even more preferably 30 MPa or more from the viewpoint of enhancing the strength of the cured body. Even with such a low loading force, sufficient strength can be imparted to the cured body. Since the strength is enhanced as the molding pressure is higher, the upper limit body of the molding pressure is not particularly limited.

The temperature during pressure molding is preferably room temperature (20° C.±15° C.) or higher, more preferably 40° C. or higher, and still more preferably 60° C. or higher, and is preferably 105° C. or lower, more preferably 90° C. or lower, and still more preferably 80° C. or lower from the viewpoint of enhancing the strength of the cured body.

The loading time during the pressure molding is preferably 30 seconds or more, more preferably 40 seconds or more, and still more preferably 50 seconds or more from the viewpoint of enhancing the strength of the cured body. Even with such a short loading time, sufficient strength can be imparted to the cured body. The upper limit value of the loading time is not particularly limited, but is preferably 60 minutes or less, more preferably 30 minutes or less, and still more preferably 15 minutes or less from the viewpoint of manufacturing efficiency.

### <Second Step>

This step is a step of drying the molded body as illustrated in FIG. 1. Thus, a cured body can be obtained.

In this step, for example, the molded body may be taken out from the mold and dried. Here, in the present specification, “drying” means reducing the moisture content in the molded body. Therefore, the drying is a concept including not only heating and drying of the molded body but also air drying and reduced-pressure drying. The drying is preferably performed until the moisture content of the molded body after drying reaches preferably 24 mass % or less, more preferably 17 mass % or less, and still more preferably 12 mass % or less.

The drying conditions can be appropriately set by a drying method using such a moisture content as an index. For example, in the case of heating and drying, the moisture content of the molded body after drying is usually 24 mass % or less when heating and drying at 105° C. for 1 hour, and the moisture content of the molded body after drying is usually 17 mass or less when heating and drying at 105° C. for 4 hours. When the molded body is heated and dried at 80° C. for 12 hours, the moisture content of the molded body after drying is usually 12 mass % or less.

After the first step and before the second step, the molded body produced in the first step can be subjected to the following step. That is, a mixture of the specific composition and the treatment liquid may be laminated on the molded body produced in the first step to subject the resulting laminate to pressure molding, and then the following step A may be repeated to produce a desired molded body. Accordingly, the strength of the cured body can be further enhanced.

### (Step A)

A step of laminating a mixture containing a specific composition and a treatment liquid on a molded body produced immediately before the step A, and subjecting the resulting laminate to pressure molding.

“Lamination on a laminate produced immediately before the step A” means that in the n-th step A, a mixture is laminated on a molded body produced in the (n−1)-th step. In the first step A, as described above, the mixture is laminated on the molded body produced in the first step, and then the resulting laminate is subjected to pressure molding. That is, this step is a step of repeatedly performing an operation of laminating a mixture of the specific composition and the treatment liquid on the molded body produced in the first step, then subjecting the resulting laminate to pressure molding to obtain a molded body, laminating a mixture of the specific composition and the treatment liquid on the molded body, and then subjecting the resulting laminate to pressure molding to obtain a molded body until a molded body having a desired height is obtained. The conditions of the pressure molding for each laminate are as described above, but for the laminate produced in the last step A, the molding pressure is preferably 20 MPa or more, more preferably 30 MPa or more, and still more preferably 40 MPa or more from the viewpoint of further enhancing the strength of the cured body. Since the strength is enhanced as the molding pressure is higher, the upper limit body of the molding pressure is not particularly limited.

When the mixture is laminated on the molded body, the thickness of the mixture per layer can be appropriately selected, and the thickness of each layer may be the same or different. The thickness of the mixture per layer is preferably 0.3 mm or more, more preferably 0.5 cm or more, and still more preferably 0.7 cm or more from the viewpoint of production efficiency, and is preferably 7 cm or less, more preferably 5.5 cm or less, and still more preferably 4 cm or less from the viewpoint of enhancing the strength of the cured body. The thickness of the mixture per layer when laminated on the laminate is preferably 0.3 to 7 cm, more preferably 0.5 to 5.5 cm, and still more preferably 0.7 to 4 cm.

Then, after a molded body having a desired height is produced, the molded body may be subjected to the second step. The second step is as described above.

In this manner, a cured body can be manufactured, and the obtained cured body can have the following properties. The compressive strength of the cured body is usually 4 MPa or more, preferably 12 MPa or more, and more preferably 24 MPa or more. The upper limit value of the compressive strength of the cured body is not particularly limited, and is, for example, 80 MPa or less.

In the present specification, the compressive strength of the cured body can be measured in accordance with JIS R 5201 (Physical Test Method for Cement). For example, a cured body (test body) is compressed by a conventionally known universal testing machine (tensile/compression testing machine), a load is measured, a maximum value is recorded, and the load is divided by a cross-sectional area to calculate a stress (compressive strength (MPa)).

The cured body manufactured by the method of the present invention can be used, for example, as a substitute for concrete. More specifically, examples thereof include, but are not limited to, members such as construction columns, beams, and slabs, solidified bodies such as blocks, foundations of buildings, and piles.

The cured body manufactured by the method of the present invention can be manufactured any number of times by applying the method of the present invention after use.

### EXAMPLES

Hereinafter, embodiments of the present invention will be described more specifically with reference to Examples. However, the present invention is not limited to the following Examples.

### 1. Analysis of Degree of Carbonation of Mortar

Thermogravimetric analysis (TG-DTA measurement) was performed under the following conditions. Then, the amount of calcium carbonate was analyzed from the weight loss amount (decarbonation amount) at 550 to 800° C., and the degree of carbonation was calculated by the following Formula (i).

### TG-DTA Measurement Conditions

Sample amount: about 20 mg
Heating rate: 10° C./min
N₂ gas flow atmosphere: 300 mL/min

$$Degree of carbonation ( \% ) = ( X \times 56 / 44 ) / Y \times 100 \qquad ( i )$$

In Formula (i),
X represents the amount of CO₂ in the composition (mg), and
Y represents the amount of Cao in the composition (mg).

### 2. Analysis of Mortar Particle Size Distribution

A volume-based cumulative distribution curve was created using both the sieving method using a sieve specified in JIS Z 8801-1:2019 “Test sieve-Part 1: Metal mesh sieve” and the laser diffraction/scattering method specified in JIS R 1629 “Method for measuring particle size distribution of fine ceramic raw material by laser diffraction/scattering method”. As a particle size distribution measuring device by a laser diffraction/scattering method, for example, Microtrac MT3300EX II (manufactured by Microtrac Retsch GmbH) was used.

### <Manufacturing of Carbonated Mortar>

### Production Example 1

A mortar simulating a construction waste material was manufactured with a mass ratio of cement:sand:water of 1:2:0.5. As the cement, ordinary Portland cement having the chemical composition illustrated in Table 1 was used. Mountain sand produced in Kakegawa City, Shizuoka Prefecture was used as the fine aggregate.

TABLE 1

| | Chemical composition | | | | | | | | | | |
|---|---|---|---|---|---|---|---|---|---|---|---|
| | SiO₂ | Al₂O₃ | Fe₂O₃ | CaO | MgO | SO₃ | Na₂O | K₂O | TiO₂ | P₂O₅ | MnO |
| mass % | 20.68 | 4.95 | 2.73 | 64.71 | 1.17 | 2.56 | 0.24 | 0.32 | 0.27 | 0.21 | 0.07 |

A 30 L pan-type mixer (HK-30S, manufactured by Kodaira Manufacturing Co., Ltd.) was used for manufacturing the mortar. Mixing was carried out at low speed; first, dry mixing was performed for 60 seconds, followed by the addition of water and mixing for 30 seconds. The mixture was stirred off and mixed again for 120 seconds. After mixing, the mortar was put into a plastic bag to have a thickness of 3 cm to produce a tile-like test specimen. The film was sealed and cured at room temperature (about 20° C.) for 1 week, and then cured in water at 40° C. for 3 months. Temperature control was carried out using an immersion heater.

After curing the mortar, pulverization was performed. At the time of pulverization, first, coarse pulverization was performed with jaw crushers (1020-B manufactured by Yoshida Seisakusho Co., Ltd., and BB50 manufactured by Retsch GmbH), and then, the resulting product was dried in a drying furnace (ISUZU ASR-115) at 105° C. Thereafter, a part was pulverized using a continuous pulverization device with a sieve (Hybrid Mill No. 1066, manufactured by Yoshida Seisakusho Co., Ltd.) to obtain a powder. The entire powder was carbonated under an environment of 20° C., 60% RH, and 5% CO₂ (Asahi Renea). The degree of carbonation and particle size distribution of the obtained carbonated mortar powder (U-HCP) were analyzed. The carbonated mortar powder (U-HCP) had a degree of carbonation of 59% (calcium carbonate content: 20 mass %).

### <Preparation of Calcium Bicarbonate Solution>

### Production Example 2

The carbonated mortar powder obtained in Production example 1 was immersed in tap water, and 100% CO₂ gas was blown into the mortar at a liquid-solid ratio of 20:1 to manufacture a calcium bicarbonate solution. This operation was performed for each consideration item to prepare a calcium bicarbonate solution. The obtained solution was measured by an ICP emission spectrometer (Thermoscientific, iCAP Pro), and consequently the Ca²⁺ concentration was 2,000 to 2,500 mass ppm and the Mg²⁺ concentration was 40 to 80 mass ppm.

### <Influence of Particle Size Distribution of Carbonated Mortar Powder>

### Examples 1 to 11

In the present Example, the influence of the particle size distribution of the carbonated mortar powder on the compressive strength of the cured body was examined.

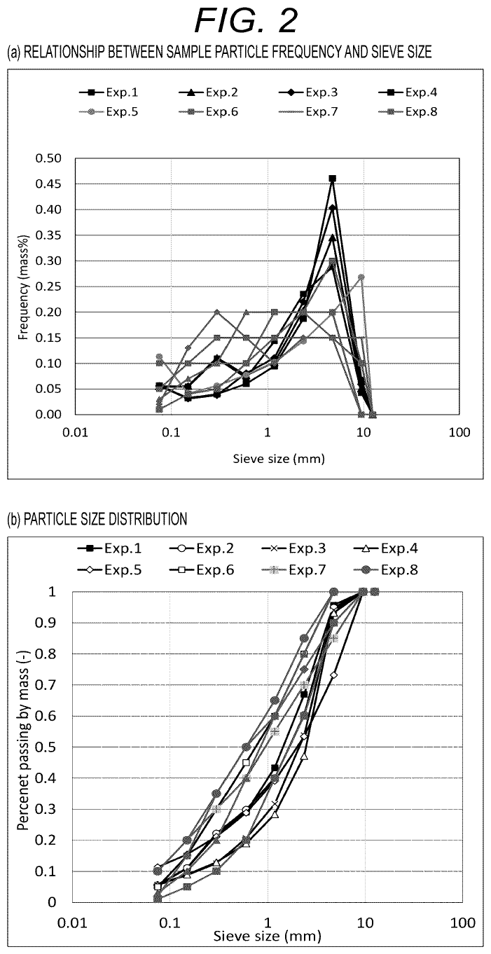

Samples of the carbonated mortar powder obtained in Production example 1 having different particle size distributions were produced using different sieves. The analysis results of the obtained samples are illustrated in FIG. 2. FIG. 2(a) shows the relationship between the particle frequency and the sieve of the sample, and FIG. 2(b) shows the particle size distribution of the sample.

The particle size distribution of the sample used in each Example is as follows.

TABLE 2

| | Sample | Particle size | Particle size |
|---|---|---|---|
| | Name | D₁₀ (mm) | D₅₀ (mm) |
| Example 1 | PSDC1 | 0.137 | 1.51 |
| (Exp. 1) | | | |
| Example 2 | PSDC2 | 0.136 | 1.76 |
| (Exp. 2) | | | |
| Example 3 | PSDC3 | 0.180 | 2.16 |
| (Exp. 3) | | | |
| Example 4 | PSDC4 | 0.175 | 2.54 |
| (Exp. 4) | | | |
| Example 5 | PSDC5 | 0.051 | 2.07 |
| (Exp. 5) | | | |
| Example 6 | PSDC6 | 0.113 | 0.590 |
| (Exp. 6) | | | |
| Example 7 | PSDC7 | 0.075 | 0.787 |
| (Exp. 7) | | | |
| Example 8 | PSDC8 | 0.075 | 0.295 |
| (Exp. 8) | | | |
| Example 9 | PSDC9 | 0.150 | 0.590 |
| (Exp. 9) | | | |
| Example 10 | PSDC10 | 0.121 | 0.393 |
| (Exp. 10) | | | |
| Example 11 | PSDC11 | 0.244 | 1.77 |
| (Exp. 11) | | | |

Each sample was placed in a simple cylindrical mold (slit mold) of φ10×20 cm, 20 mass % of the calcium bicarbonate aqueous solution obtained in Production example 2 was added to the sample, and the mixture was stirred to level the driving surface. A loading plate was placed thereon, and loaded (hereinafter also referred to as “pre-loading”) at a stress of 15 MPa using a 250 kN universal tester (Shimazu AG-250KN) at room temperature, and held for about 1 minute. After pre-loading, the molded body was taken out from the simple mold to obtain disk-shaped molded bodies each having a diameter of φ10×4 cm. Each molded body was dried in a drying furnace at 105° C. for 24 hours to obtain each cured body.

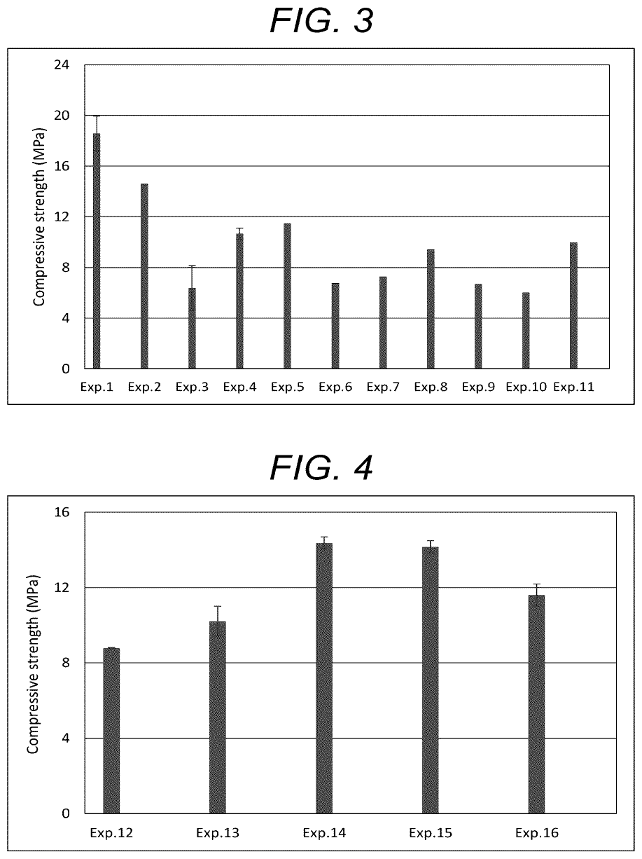

For each cured body, a loading plate of a compression testing machine for mortar was installed such that the center of the loading plate overlapped the center of the cured body, and in this state, a compression test was performed with the same testing device as that for pre-loading, and the maximum load was divided by the area of the loading plate to determine the compressive strength. The results are illustrated in FIG. 3.

### <Influence of Addition Amount of Calcium Bicarbonate Solution>

### Examples 12 to 16 (Exp. 12 to 16)

In the present Example, the influence of the addition amount of the calcium bicarbonate solution on the compressive strength of the cured body was examined using the carbonated mortar powder (PSDC1) having the same particle size distribution as in Example 1.

A cured body was manufactured by the same operation as in Example 1 except that the addition amount of the calcium bicarbonate solution to the carbonated mortar was changed to 10 mass % (Exp. 12), 15 mass % (Exp. 13), 20 mass (Exp. 14), 25 mass % (Exp. 15), or 30 mass % (Exp. 16). Then, the compressive strength of each cured body was measured. The results are illustrated in FIG. 4.

### <Influence of Loading Time During Pressure Molding>

### Examples 17 to 19 (Exp. 17 to 19)

In the present Example, the influence of the loading time in a case where the pre-loading is performed on the compressive strength of the cured body was examined using the carbonated mortar powder (PSDC1) having the same particle size distribution as in Example 1.

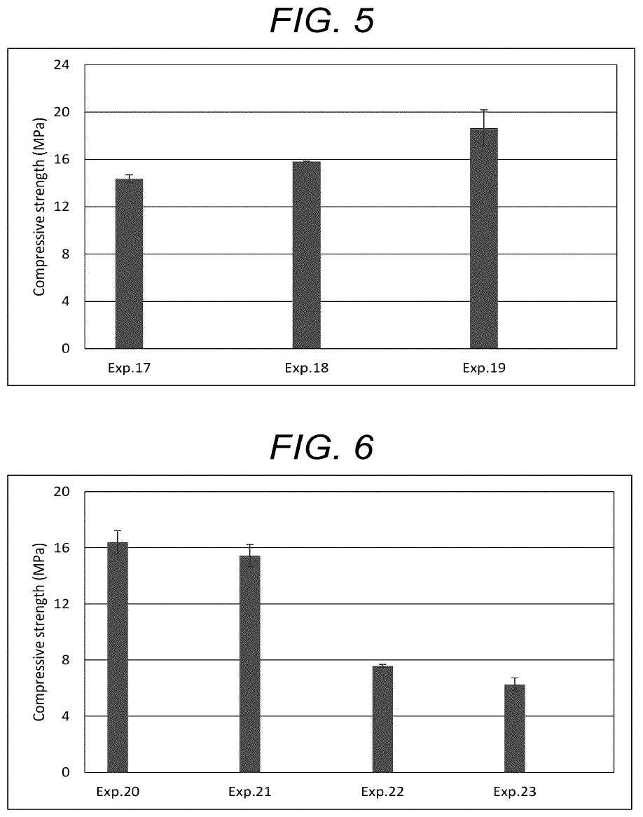

A cured body was manufactured by the same operations as in Example 1 except that the loading time for the carbonated mortar powder at the time of pressure molding was changed to 1 minute (Exp. 17), 12 minutes (Exp. 18), and 30 minutes (Exp. 19). Then, the compressive strength of each cured body was measured. The results are illustrated in FIG. 5.

### <Influence of Drying Time of Molded Body>

### Examples 20 to 23 (Exp. 20 to 23)

In the present Example, the influence of the drying time of the molded body on the compressive strength of the cured body was examined using the carbonated mortar powder (PSDC1) having the same particle size distribution as in Example 1.

A cured body was manufactured by the same operations as in Example 1 except that the drying time of the molded body produced from the carbonated mortar was changed to 12 hours (Exp. 20), 8 hours (Exp. 21), 4 hours (Exp. 22), and 1 hour (Exp. 23). Then, the compressive strength of each cured body was measured. The results are illustrated in FIG. 6.

### <Influence of Temperature During Pressure Molding>

### Examples 24 to 28 (Exp. 24 to 28)

In the present Example, the influence of the temperature during loading of the molded body on the compressive strength of the cured body was examined using the carbonated mortar powder (PSDC1) having the same particle size distribution as in Example 1.

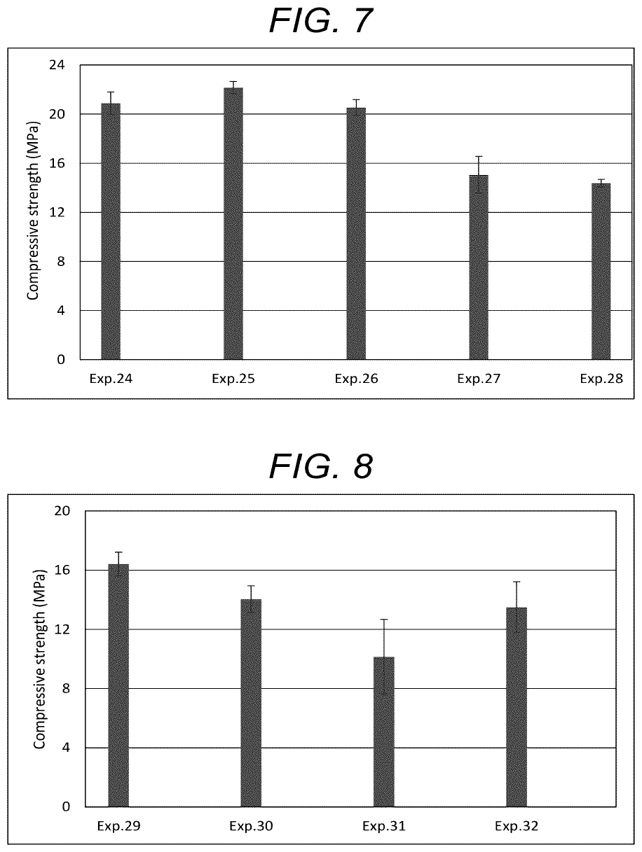

A cured body was manufactured by the same operations as in Example 1 except that the temperature at the time of loading the molded body was changed to 105° C. (Exp. 24), 80° C. (Exp. 25), 60° C., (Exp. 26), 40° C. (Exp. 27), and 20° C. (Exp. 28). Then, the compressive strength of each cured body was measured. The results are illustrated in FIG. 7.

### <Influence of Drying Temperature of Molded Body>

### Examples 29 to 32 (Exp. 29 to 32)

In the present Example, the influence of the drying temperature of the molded body after loading on the compressive strength of the cured body was examined using the carbonated mortar powder (PSDC1) having the same particle size distribution as in Example 1.

A cured body was manufactured by the same operations as in Example 1 except that the drying temperature of the molded body was changed to 105° C. (Exp. 29), 80° C. (Exp. 30), 60° C. (Exp. 31), and 40° C. (Exp. 32). Then, the compressive strength of each cured body was measured. The results are illustrated in FIG. 8.

### <Influence of Type of Soluble Alkaline Earth Metal Salt>

### Examples 33 to 35 (Exp. 33 to 35)

In the present Example, the influence of the type of the soluble alkaline earth metal salt on the compressive strength of the cured body was examined using the carbonated mortar powder (PSDC1) having the same particle size distribution as in Example 1.

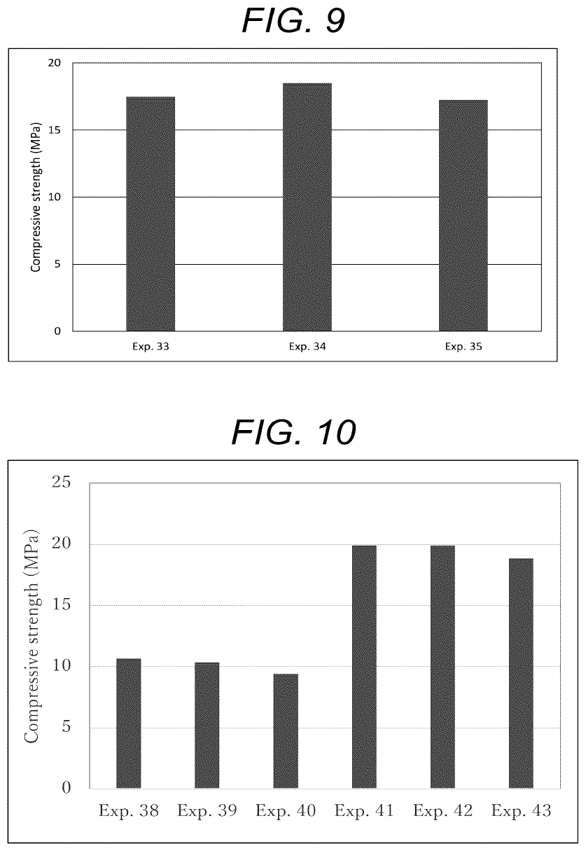

A cured body was manufactured by the same operation as in Example 1 except that a solution containing the following three types of soluble alkaline earth metal salts was used instead of the calcium bicarbonate solution, and the solution was pre-loaded at a stress of 20 MPa. Then, the compressive strength of each cured body was measured. The results are illustrated in FIG. 9.
Exp. 33: CaCl₂) (aqueous solution obtained by adding pure CaCl₂ to pure water at a mass ratio of 5 mass %).
Exp. 34: MgCl₂ (aqueous solution obtained by adding pure MgCl₂ to pure water at a mass ratio of 5 mass %).
Exp. 35: Ca-Sea Water (A bicarbonated seawater solution produced by adding carbonated mortar powder to artificial seawater manufactured by using artificial seawater powder and pure water at a liquid solid ratio of 20:1, blowing 100% CO₂ gas thereinto, and increasing the concentration of calcium bicarbonate. The Ca²⁺ concentration measured with an ICP emission spectrometer was about 2,060 mass ppm.)

### <Study of Mixed Composition of Calcium Carbonate and Magnesium Carbonate>

### Example 36

A cured body was manufactured by the same operations as in Example 1 except for using a sample in which 2 mass % of a magnesite pulverized product having a particle size D₁₀ of 0.005 mm and a particle size D₅₀ of 0.014 mm was added to carbonated mortar powder (PSDC1) having the same particle size distribution as in Example 1. Then, the compressive strength of the cured body was measured. As a result, the compressive strength was 8.5 MPa.

### <Confirmation of Reuse of Cured Body>

### Example 37

In this example, the reusability of the cured body was examined.

The cured body manufactured in Example 1 after the measurement of the compressive strength was coarsely pulverized with a jaw crusher and further pulverized with a sieving continuous pulverization device to obtain a powder. A sample was produced by adjusting the particle size distribution of the powder using a sieve. The grain size of the sample was comparable to PSDC1. Using this sample, a cured body was manufactured again by the same operation as in Example 1, and a compression test was performed. Four cured bodies were manufactured. The compressive strength of the cured body was 16.3 MPa on average, and the standard deviation was 1.5 MPa.

From these results, it is found that it is possible to manufacture a cured body having sufficient strength even when the loading time is short without requiring a high molding pressure, and the cured body can be reused any number of times.

### <Manufacturing of Carbonated Mortar>

### Production Example 3

Mortar simulating the composition of recycled concrete waste material was manufactured. The mixture used a 30 L pan-type mixer (HK-30S, Kodaira Manufacturing Co., Ltd.), and the mass ratio of cement:sand:water was 1:2:0.5. The mixing process was strictly in accordance with JIS standard guidelines. A specific mixing procedure is as follows.

Water was poured into the container and then cement was added. The mixture was then stirred at a low speed of 140 rpm for 30 seconds. The cement paste adhering to the walls of the container was carefully scraped off before putting in the sand. Then, sand was added to the cement paste and mixed at 140 rpm, and the mixture was further continued for 30 seconds. Thereafter, the stirring speed was increased to 285 rpm and continued for another 30 seconds. Again, all the mortar adhering to the wall of the container was scraped off, and mixing was continued at 285 rpm for 60 seconds. The obtained mortar was sufficiently mixed with a spoon, and then about 6 kg of mortar was poured into a plastic bag. The bag filled with mortar was immersed in water to promote curing, and maintained at 40° C. for 1 month. After this initial curing, the bag was transferred to an environment of 20° C. and cured for an additional 5 months. Next, the cured mortar sample was pulverized using a jaw crusher (1020-B manufactured by Yoshida Seisakusho Co., Ltd., and BB50 manufactured by Retsch GmbH) and a pulverizer (1025-HB manufactured by Yoshida Seisakusho Co., Ltd., 1066). These pulverizers were used to obtain small particles.

After the pulverizing step, the mortar powder functioning as carbonated mortar was sieved, and the particles were separated based on the particle size. The carbonated mortar was classified into the following size ranges: 4.76 mm or more and less than 9.5 mm, 2.36 mm or more and less than 4.75 mm, 1.18 mm or more and less than 2.36 mm, 0.6 mm or more and less than 1.18 mm, 0.3 mm or more and less than 0.6 mm, 0.15 mm or more and less than 0.3 mm, 0.075 mm or more and less than 0.15 mm, and less than 0.075 mm.

Next, the particles were carbonated in a CO₂ chamber (E20F01-Marui) at 20° C., a relative humidity of 90%, and a CO₂ concentration of 5% for 3 months. The degree of carbonation of the carbonated mortar was more than 60%.

Using carbonated mortar of various particle sizes, samples having the same particle size distribution as PSDC1 used in Example 1 and samples having the particle size distribution illustrated in the following table were produced.

TABLE 3

| | Sample | Particle size | Particle size |
|---|---|---|---|
| | Name | D₁₀ (mm) | D₅₀ (mm) |
| Examples 38 to 40 | PSDC1 | 0.137 | 1.51 |
| (Exp. 38 to 40) | | | |
| Examples 41 to 43 | | | |
| (Exp. 41 to 43) | | | |
| Examples 59 to 63 | | | |
| (Exp. 59 to 63) | | | |
| Examples 44 to 48 | PSDC12 | 0.075 | 0.6 |
| (Exp. 44 to 48) | | | |
| Examples 49 to 53 | | | |
| (Exp.49 to 53) | | | |
| Examples 54 to 58 | | | |
| (Exp. 54 to 58) | | | |

### Production Example 4

### <Preparation of Calcium Bicarbonate Solution>

As a calcium source, a hydrated cement paste powder having a particle size of 150 μm or less, which imitates a regenerated powder of concrete waste material, was used. Next, the hydrated cement paste powder and deionized water were mixed, 100% of CO₂ gas was bubbled into the mixed liquid, and then the mixture was stirred and mixed at 500 rpm for 6 hours or more. The mass ratio between the hydrated cement paste powder and the deionized water was 1:10, and the temperature at the time of mixing was adjusted to about 5° C. using a heating extractor. Ca²⁺ was extracted into the mixed liquid by CO₂ dissolution, and then the mixed liquid was filtered through a 5 μm filter to remove impurity powder, thereby obtaining a calcium bicarbonate solution. The calcium bicarbonate aqueous solution was then transferred to a tank, which was also maintained at about 5° C. This operation was performed for each examination item, and a calcium bicarbonate solution was prepared. The prepared calcium bicarbonate solution was measured using an ICP emission spectrometer (Thermoscientific, iCAP Pro), and the Ca²⁺ concentration was about 600 to 900 mass ppm, while the Mg²⁺ concentration was 15.9 to 18.3 mass ppm.

### <Preparation of Calcium Chloride Aqueous Solution>

### Production Example 5

A calcium chloride powder (FUJIFILM Wako Pure Chemical Corporation) was sufficiently mixed with deionized water at a ratio of 1:20 until all the calcium chloride particles were completely dissolved, to prepare a calcium chloride aqueous solution having a calcium chloride concentration of 0.45 mol/L.

### <Preparation of Magnesium Chloride Aqueous Solution>

### Production Example 6

Magnesium chloride powder (FUJIFILM Wako Pure Chemical Corporation) was sufficiently mixed with deionized water at a ratio of 1:20 until all the magnesium chloride particles were completely dissolved, to prepare a magnesium chloride aqueous solution having a magnesium chloride concentration of 0.53 mol/L.

### <Preparation of Bicarbonated Seawater Solution>

### Production Example 7

A carbonated cement paste powder pulverized into particles of 150 μm or less was added to artificial seawater manufactured from an artificial seawater powder and pure water at a liquid-solid ratio of 1:10, and 100% CO₂ gas was blown thereinto to prepare a bicarbonated seawater solution having a high calcium bicarbonate concentration. The solution from which particles had been removed using a 5 μm filter was measured with an ICP emission spectrophotometer, and the Ca²⁺ concentration was 2,252 mass ppm.

### <Preparation of Hydrochloric Acid Aqueous Solution>

### Production Example 8

Hydrochloric acid (36% HCl, FUJIFILM Wako Pure Chemical Corporation) was mixed with deionized water at a ratio of 1:4 to prepare an aqueous hydrochloric acid solution having a hydrochloric acid concentration of 2.9 mol/L.

### <Preparation of Calcium Sulfate Aqueous Solution>

### Production Example 9

A calcium sulfate powder (FUJIFILM Wako Pure Chemical Corporation) was sufficiently mixed with deionized water at a ratio of 1:20 until all calcium sulfate particles were completely dissolved, to prepare a calcium sulfate aqueous solution having a calcium sulfate concentration of 0.29 mol/L.

### <Influence of Mass Ratio of Cement/Sand/Water>

### Examples 38 to 40 (Exp. 38 to 40)

In this example, the influence of the mass ratio of cement/sand/water in the carbonated mortar on the compressive strength of the cured body was examined.

First, as a sample, a carbonated mortar powder having a maximum particle size of 9.5 mm and having the same particle size distribution as that of the PSDC1 of Example 1 was manufactured by changing the mass ratio of cement/sand/water to 1/3/0.5 (Exp. 38), 1/4/0.5 (Exp. 39), and 1/6/0.5 (Exp. 40) by the same operation as in Production example 3.

Next, 20 mass % of the calcium bicarbonate solution prepared in Production example 4 was added to the sample, and the mixture was mixed in a metal mixing pan. Mixing was performed using a trowel for 60 seconds until a uniform appearance and desired consistency were obtained. The mixture was then carefully transferred using a scoop and a pointed trowel into a steel mold with dimensions of φ10×20 cm. While discharging the mixture from the mold, the vicinity of the upper end of the mixture was moved with a scoop or trowel to ensure a symmetrical distribution, and placed in the mold to a thickness of about 5 cm while minimizing the separation (segregation) of the carbonated mortar in the mold. In addition, 5 to 6 strokes were applied across the mold cross-section using a tamping rod with a diameter of 10 mm to distribute evenly. The mixture was then compressed while the rod was stroked 3 to 4 times using a 3 cm diameter rod cylinder to produce a flat surface. Subsequently, the mold was vibrated for 1 minute using a vibrator (MIC-365, made by MARUI & Co., Ltd.) having a frequency of 40 Hz. The samples were then compressed in the mold at a pressure of 15 MPa using an autograph (AG-250kNG, manufactured by Shimadzu Corporation). The pressurization rate was set to 1 MPa/min. As the mold, a mold having sufficient hardness was used in order to prevent deformation of the molded product in the horizontal direction.

The molded product was then dried in an oven at 105° C. for 4 hours to ensure precipitation of ion diffusion from the pressurized solution under load. After 4 hours, the molded body was taken out from the mold, and further dried in an oven at 105° C. for 8 hours before the test to manufacture a cured body. Then, the compressive strength of each cured body was measured. The results are illustrated in FIG. 10.

### <Influence of Mass Ratio of Cement/Sand/Water>

### Examples 41 to 43 (Exp. 41 to 43)

First, carbonated mortar powders in which the mass ratio of cement/sand/water was changed to 1/3/0.5 (Exp. 41), 1/4/0.5 (Exp. 42), and 1/6/0.5 (Exp. 43) were manufactured as samples by the same operation as in Examples 38 to 40. Subsequently, a cured body was manufactured by the same operation as in Examples 38 to 40 except that the pressurization condition of the molded body was changed to 25 MPa using this sample. Then, the compressive strength of each cured body was measured. The results are illustrated in FIG. 10.

### <Influence of Thickness of Mixture Per Layer of Laminate>

### Example 44 (Exp. 44)

In the present Example, a carbonated mortar powder having a maximum particle size of 4.75 mm and having the same particle size distribution as that of the PSDC12 was used as a sample, and the influence of the thickness of the mixture per layer at the time of producing the laminate on the compressive strength of the cured body was examined. First, 20 mass % of the calcium bicarbonate solution prepared in Production example 4 was added to the sample, and the mixture was mixed in a metal mixing pan by the same operation as in Example 38, and the mixing was performed using a trowel for 60 seconds until a uniform appearance and a desired consistency were obtained. Subsequently, the mixture was carefully transferred into a steel mold with dimensions of 95×10 cm using a scoop and a pointed trowel. While discharging the mixture from the mold, the vicinity of the upper end of the mixture was moved with a scoop or trowel and placed in the mold to a thickness of 1.25 cm while minimizing the separation (segregation) of the carbonated mortar in the mold. In addition, 5 to 6 strokes were applied across the mold cross-section using a tamping rod with a diameter of 10 mm to distribute evenly. The mixture was then compressed while the rod was stroked 3 to 4 times using a 3 cm diameter rod cylinder to produce a flat surface. Subsequently, the mold was vibrated for 1 minute using a vibrator (MIC-365, made by MARUI & Co., Ltd.) having a frequency of 40 Hz. The samples were then compressed in the mold at a pressure of 15 MPa using an autograph (AG-250kNG, manufactured by Shimadzu Corporation). The pressurization rate was set to 1 MPa/min.

Next, the mixture was placed in a mold until the thickness reached 1.25 cm on the molded body, a flat surface was produced by the same operation as described above, the mold was vibrated, and then the sample was compressed at a pressure of 15 MPa in the mold. The pressurization rate was set to 1 MPa/min.

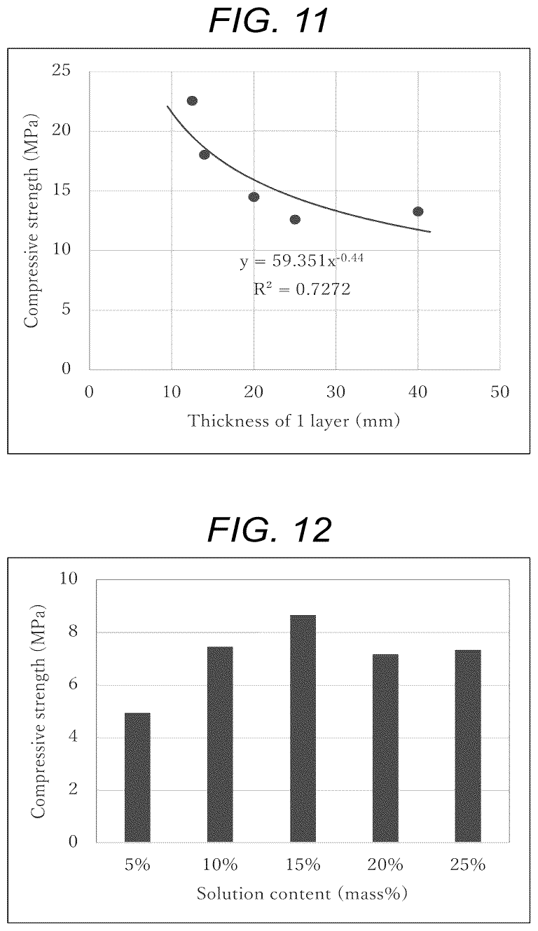

Next, on the laminate, the mixture was placed in a mold until the thickness reached 1.25 cm on the molded body, a flat surface was produced by the same operation as described above, the mold was vibrated, and then the sample was compressed at a pressure of 15 MPa in the mold. This operation was repeated until the height reached 10 cm. Then, the molded product obtained in the last step was dried in an oven at 105° C. for 4 hours to ensure precipitation of ion diffusion from the pressurized solution under load. After 4 hours, the molded body was taken out from the mold, and further dried in an oven at 105° C. for 20 hours before the test to manufacture a cured body. Then, the compressive strength of the cured body was measured. The results are illustrated in FIG. 11.

### Example 45 (Exp. 45)

A cured body was manufactured by the same operations as in Example 44 except that the thickness of the mixture per layer was changed to 1.5 cm. Then, the compressive strength of the cured body was measured. The results are illustrated in FIG. 11.

### Example 46 (Exp. 46)

A cured body was manufactured by the same operations as in Example 44 except that the thickness of the mixture layer per layer was changed to 2 cm. Then, the compressive strength of the cured body was measured. The results are illustrated in FIG. 11.

### Example 47 (Exp. 47)

A cured body was manufactured by the same operations as in Example 44 except that the thickness of the layer of the mixture was changed to 2.5 cm. Then, the compressive strength of the cured body was measured. The results are illustrated in FIG. 11.

### Example 48 (Exp. 48)

A cured body was manufactured by the same operations as in Example 44 except that the thickness of the mixture layer per layer was changed to 4 cm. Then, the compressive strength of the cured body was measured. The results are illustrated in FIG. 11.

### <Influence of Addition Amount of Calcium Bicarbonate Solution>

### Examples 49 to 53 (Exp. 49 to 53)

In the present Example, a carbonated mortar powder having a maximum particle size of 4.75 mm and having the same particle size distribution as that of the PSDC12 was used as a sample, and the influence of the addition amount of the calcium bicarbonate solution on the compressive strength of the cured body was examined while the addition amount of the calcium bicarbonate solution to the carbonated mortar was changed to 5 mass % (Exp. 49), 10 mass % (Exp. 50), 15 mass (Exp. 51), 20 mass % (Exp. 52), and 25 mass % (Exp. 53).

First, the calcium bicarbonate solution prepared in Production example 4 was added to the sample in the above addition amount, and mixed in a metal mixing pan by the same operation as in Example 41, and the mixing was performed using a trowel for 60 seconds until a uniform appearance and a desired consistency were obtained. Subsequently, the mixture was carefully transferred into a steel mold with dimensions of φ5×10 cm using a scoop and a pointed trowel. While discharging the mixture from the mold, the vicinity of the upper end of the mixture was moved with a scoop or trowel and placed in the mold to a thickness of 5 cm while minimizing the separation (segregation) of the carbonated mortar in the mold. In addition, 5 to 6 strokes were applied across the mold cross-section using a tamping rod with a diameter of 10 mm to distribute evenly. The mixture was then compressed while the rod was stroked 3 to 4 times using a 3 cm diameter rod cylinder to produce a flat surface. Subsequently, the mold was vibrated for 1 minute using a vibrator (MIC-365, made by MARUI & Co., Ltd.) having a frequency of 40 Hz. The samples were then compressed in the mold at a pressure of 25 MPa using an autograph (AG-250kNG, manufactured by Shimadzu Corporation). The pressurization rate was set to 2 MPa/min.

The molded product was then dried in an oven at 105° C. for 4 hours to ensure precipitation of ion diffusion from the pressurized solution under load. After 4 hours, the molded body was taken out from the mold, and further dried in an oven at 105° C. for 8 hours before the test to manufacture a cured body. Then, the compressive strength of each cured body was measured. The results are illustrated in FIG. 12.

<Influence of Preheating of Carbonated Mortar Before Mixing with Treatment Liquid>

### Examples 54 to 58 (Exp. 54 to 58)

In the present Example, a carbonated mortar powder having a maximum particle size of 4.75 mm and having the same particle size distribution as that of the PSDC12 was used as a sample, and the influence of preheating of the carbonated mortar on the compressive strength of the cured body was examined before mixing with a calcium bicarbonate solution.

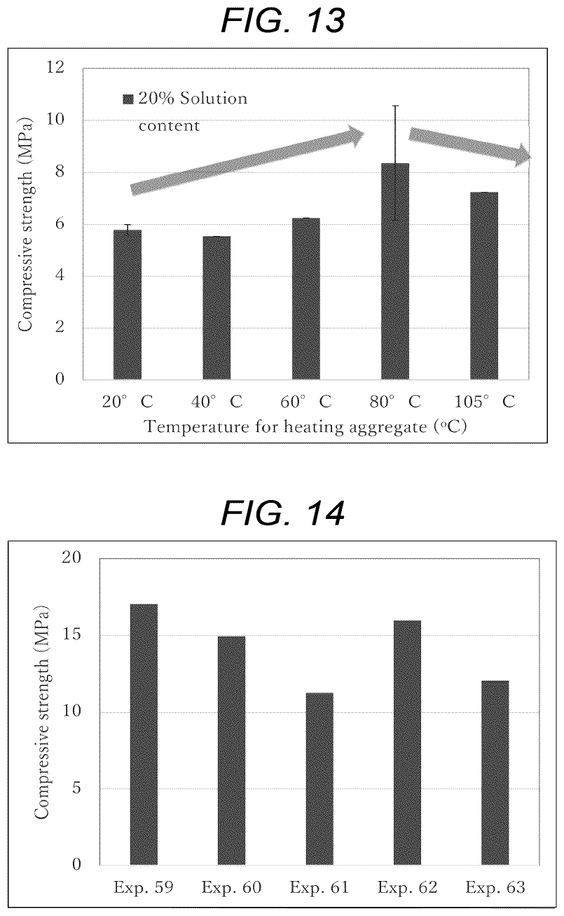

A cured body was manufactured by the same operations as in Example 49 except that before mixing with the calcium bicarbonate solution, the carbonated mortar was heated in an oven at 20° C. (Exp. 54), 40° C. (Exp. 55), 60° C. (Exp. 56), 80° C. (Exp. 57), and 105° C. (Exp. 58) for 3 hours. Then, the compressive strength of each cured body was measured. The results are illustrated in FIG. 13.

### Examples 59 to 63 (Exp. 59 to 63)

### <Influence of Type of Treatment Liquid>

In the present Example, a carbonated mortar powder having the same particle size distribution as that of the PSDC1 of Example 1 was used as a sample, and the influence of the type of the treatment liquid on the compressive strength of the cured body was examined. The following three types of treatment liquids were used.
Exp. 59: calcium chloride aqueous solution prepared in Production example 5
Exp. 60: magnesium chloride aqueous solution prepared in Production example 6
Exp. 61: bicarbonate seawater solution prepared in Production example 7
Exp. 62: hydrochloric acid aqueous solution prepared in Production example 8
Exp. 63: calcium sulfate aqueous solution prepared in Production example 9

First, 20 mass % of the treatment liquid described above was added to the sample, and the mixture was mixed in a metal mixing pan by the same operation as in Example 38, and the mixing was performed using a trowel for 60 seconds until a uniform appearance and a desired consistency were obtained. The mixture was then carefully transferred using a scoop and a pointed trowel into a steel mold with dimensions of φ4×10 cm. While discharging the mixture from the mold, the vicinity of the upper end of the mixture was moved with a scoop or trowel and placed in the mold to a thickness of 7 cm while minimizing the separation (segregation) of the carbonated mortar in the mold. In addition, 5 to 6 strokes were applied across the mold cross-section using a tamping rod with a diameter of 10 mm to distribute evenly. The mixture was then compressed while the rod was stroked 3 to 4 times using a 3 cm diameter rod cylinder to produce a flat surface. Subsequently, the mold was vibrated for 1 minute using a vibrator (MIC-365, made by MARUI & Co., Ltd.) having a frequency of 40 Hz. The samples were then compressed in the mold at a pressure of 15 MPa using an autograph (AG-250kNG, manufactured by Shimadzu Corporation). The pressurization rate was set to 1 MPa/min.

Next, the molded product was dried in an oven at 105° C. for 12 hours to manufacture a cured body. Then, the compressive strength of each cured body was measured. The results are illustrated in FIG. 14.

From these results, it can be seen that a cured body has sufficient strength even when the cured body is manufactured from a molded product in which a mixture of the specific composition and the treatment liquid is sequentially laminated. In addition, it is found that a cured body having sufficient strength can be manufactured even when an aqueous solution of a soluble alkaline earth metal salt or an inorganic acid aqueous solution is used as the treatment liquid instead of the calcium bicarbonate solution.

1. A method of manufacturing a cured body, the method comprising:
mixing a composition comprising (i) a carbonate comprising calcium and/or magnesium, or a hydrate of the carbonate, and (ii-a) a liquid comprising a soluble alkaline earth metal salt or (ii-b) inorganic acid aqueous solution, to obtain a resulting mixture, and subjecting the resulting mixture to pressure molding to produce a molded body; and
drying the molded body.

2. The method of claim 1, further comprising:
repeating, after the mixing and before the drying, laminating the resulting mixture on the molded body produced in the mixing, to obtain a resulting laminate, and subjecting the resulting laminate to pressure molding, and then, producing a desired molded body.

3. The method of claim 1, wherein the composition has a particle size D₁₀ in a range of from 0.10 to 0.75 mm and a particle size D₅₀ in a range of from 1.0 to 5.0 mm.

4. The method of claim 1, comprising using an amount of liquid in a range of from 5 to 40 mass %, with respect to composition mass.

5. The method of claim 1, wherein the soluble alkaline earth metal salt comprises a soluble calcium salt and/or a soluble magnesium salt.

6. The method of claim 1, wherein the soluble alkaline earth metal salt is present and comprises calcium bicarbonate, calcium sulfate, calcium chloride, magnesium bicarbonate, magnesium sulfate, magnesium nitrate, magnesium acetate, and/or magnesium chloride.

7. The method of claim 1, wherein the inorganic acid aqueous solution is present an comprises an inorganic acid comprising hydrochloric acid, carbonic acid, and/or sulfuric acid.

8. The method of claim 1, wherein pressure molding is performed for 30 seconds or more.

9. The method of claim 1, wherein the molded product is dried until a moisture content of the molded body after drying becomes 24 mass % or less.

10. The method of claim 1, wherein the composition has a particle size D₁₀ in a range of from 0.10 to 0.75 mm and a particle size D₅₀ in a range of from 1.0 to 5.0 mm, and
wherein an amount of liquid used in a range of from 5 to 40 mass %, with respect to composition mass.

11. The method of claim 1, wherein the soluble alkaline earth metal salt is present and comprises a soluble calcium salt.

12. The method of claim 1, wherein the soluble alkaline earth metal salt is present and comprises a soluble magnesium salt.

13. The method of claim 1, wherein the soluble alkaline earth metal salt is present and comprises a soluble calcium salt and a soluble magnesium salt.

14. The method of claim 1, wherein the soluble alkaline earth metal salt is present and comprises calcium bicarbonate, calcium sulfate, calcium chloride, magnesium bicarbonate, magnesium sulfate, magnesium nitrate, magnesium acetate, and/or magnesium chloride, and
wherein pressure molding is performed for 30 seconds or more.

15. The method of claim 1, wherein the inorganic acid aqueous solution is present an comprises an inorganic acid comprising hydrochloric acid, carbonic acid, and/or sulfuric acid, and
wherein pressure molding is performed for 30 seconds or more.

16. The method of claim 1, wherein the soluble alkaline earth metal salt is present and comprises calcium bicarbonate, calcium sulfate, calcium chloride, magnesium bicarbonate, magnesium sulfate, magnesium nitrate, magnesium acetate, and/or magnesium chloride,
wherein pressure molding is performed for 30 seconds or more, and
wherein the molded product is dried until a moisture content of the molded body after drying becomes 24 mass % or less.

17. The method of claim 1, wherein the inorganic acid aqueous solution is present an comprises an inorganic acid comprising hydrochloric acid, carbonic acid, and/or sulfuric acid,
wherein pressure molding is performed for 30 seconds or more, and
wherein the molded product is dried until a moisture content of the molded body after drying becomes 24 mass % or less.
